(19) United States
(12) Patent Application Publication
(10) Pub. No.: US 2007/0258235 A1
(43) Pub. Date: Nov. 8, 2007

(54) Elliptical Reflector and Curved Lens System for a Portable Light

(75) Inventors: Michael D. Brockel, Wichita, KS (US); Keith Vincent Skidmore, Newton, KS (US); James M. Cormier, Wichita, KS (US); Michael Kwok Ying Chan, Hong Kong (CN)

Correspondence Address: LEYDIG, VOIT & MAYER, LTD.;(SEATTLE OFFICE), TWO PRUDENTIAL PLAZA, SUITE 4900, CHICAGO, IL, 60601-6731, US

(73) Assignee: The Coleman Company, Inc., Wichita, KS (US)

(21) Appl. No.: 10/596,276

(22) PCT Filed: Dec. 8, 2004
(86) PCT No.: PCT/US04/41096

§ 371 Date: Jun. 7, 2006

Related U.S. Application Data
(60) Provisional application No. 60/527,693, filed on Dec. 8, 2003.
(60) Provisional application No. 60/550,414, filed on Mar. 5, 2004.

(51) Int. Cl. F21L 4/00; F21V 7/00

(52) U.S. Cl. 362/190; 362/208; 362/296

(57) ABSTRACT

An elliptical reflector is provided that produces a small, circular, concentrated light beam and a less bright, larger outer elliptical flood light. The outer rim of the reflector is curved, and a matching curved lens is provided for covering the outer rim of the reflector. The curved outer rim of the reflector and the curved lens permit the light beam to extend in a broader horizontal pattern of light, potentially providing close to 180 degrees of illumination. If desired, a portion of the light can be directed downward to light a dark path, for instance.

### CROSS REFERENCE TO RELATED APPLICATIONS

This patent application claims priority to U.S. provisional Patent Application No. 60/550,414 filed Mar. 5, 2004, and U.S. provisional Patent Application No. 60/527,693 filed Dec. 8, 2003, both of which are incorporated herein in their entireties.

### TECHNICAL FIELD OF THE INVENTION

The present invention relates to an illumination reflector and lens system, and more particularly to a reflector and lens system that project a flood light pattern from a light source.

### BACKGROUND OF THE INVENTION

While a portable lighting apparatus such as a flashlight having a small filament light source is generally constructed with a reflector shaped to produce a narrowly focused spot beam for illumination of a distant object, it is often desired to produce a broader flood beam to illuminate a close-by extended area using the filament light source. U.S. Pat. No. 5,424,927 issued to David R. Schaller et al., issued Jun. 13, 1996, discloses a flashlight having a parabolic reflector that terminates in a rectangular opening. The parabolic reflector collimates light emitted from a filament positioned at the reflector focal point. A rectangular electro-optic device driven by electronic circuitry covers the rectangular opening and operates in a first state to pass the collimated light to form a spot beam. In order to produce a flood beam, the state of the electro-optic device is switched to refract the collimated beam produced by the parabolic reflector. The use of both an electro-optic device and the required electronic drive circuitry, however, is costly and the electro-optic device reduces the amount of light directed from the reflector.

Reflectors for rectangular openings are known which have a pair of opposing parabolic or elliptic reflecting portions that are joined by planar reflective portions. The reflections from the planar reflective portions, however, often result in a non-uniform flood beam. U.S. Pat. No. 4,386,824 issued to Geoffrey R. Draper Jun. 7, 1983 discloses a motor vehicle rectangular lamp reflector which has parabolic lateral reflective portions and upper and lower reflective portions shaped to provide an infinite number of parabolic or elliptical curves. The parabolic or elliptical curves extend forwardly of the reflector body and terminate at the rectangular front opening thereof. The upper and lower reflective portions have foci (focal points) and focal axes that are coincident and increase progressively in focal length from the center of the reflector to the lateral reflective portions. As a result, a relatively complex arrangement of curves on upper and lower reflective portions is required in order to produce a flood beam. Further, the use of concave parabolic lateral reflectors results in non-uniformities in the produced flood beam.

U.S. Pat. No. 6,048,084 to Sedovic, et al., which is assigned to the owner of the present invention, is directed to a reflector of a lighting apparatus such as a flashlight. The reflector has a cupped shaped body with a first pair of opposing walls and a second pair of opposing walls extending from an aperture at the cupped shaped body center to a rectangular opening.

The internal surfaces of the walls of the Sedovic reflector are reflective. Each of the first pair of walls is concavely curved with a focus point in front of a filament light source inside the cupped shaped body and each of the second pair of walls is convexly curved with a focus point exterior to the cupped shaped body. The first pair of opposing walls and the second pair of opposing walls are shaped to reflect light from the filament light source through the rectangular opening to form a predetermined flood beam by breaking up the filament image and reflecting the resulting light.

The reflector disclosed in the Sedovic patent provides a variety of benefits, including the provision of a rectangular light pattern that is wider horizontally than vertically. Although the reflector in the Sedovic, et al. patent works well for its intended purpose, because the reflector includes four sides, there are dead spaces within the reflector in which light is not reflected outward, but instead reflects in random directions. The resulting light pattern, while illuminating a large square area, includes a number of dark lines and bright spots.

### SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

In accordance with an embodiment of the invention, an elliptical reflector is provided that produces a small, circular, concentrated light beam and a less bright, larger outer elliptical circle. In accordance with an embodiment of the invention, the outer rim of the reflector is curved, and a matching curved lens is provided for covering the outer rim of the reflector. The curved outer rim of the reflector and the curved lens permit the light beam to extend in a broader horizontal pattern of light, potentially providing close to 180 degrees of illumination. In addition, the elliptical reflector and curved lens may be used to constrain light in a vertical dimension.

In accordance with an embodiment, the elliptical reflector and curved lens may be configured to provide a light pattern that closely matches the seeing capability of a human. That is, the small, circular, concentrated light beam matches the direct viewing area of the eyes, and the less bright, larger elliptical light more closely matches the peripheral vision of a user. Instead of light being directed upward or downward where it is not needed, the light is better utilized in a wider, horizontal plane. In addition, if desired, the light can be directed downward to light a dark path, for instance. To do so, in accordance with an embodiment of the invention, the bottom portion of the elliptical reflector may be opened to permit reflection at a broader pattern downward. Alternatively, the internal walls of the reflector may be configured and/or the bulb may be positioned to direct some light downward.

Other features of the invention will become apparent from the following detailed description when taken in conjunction with the drawings, in which:

### BRIEF DESCRIPTION OF THE DRAWINGS

FIG. 1 is front side perspective view of a flashlight incorporating an embodiment of the present invention;

FIG. 2 is a top view of the flashlight of FIG. 1;

FIG. 3 is a sectional view taken vertically through a reflector that may be used with the flashlight of FIG. 1 in accordance with an embodiment of the invention;

FIG. 4 is a sectional view taken horizontally through a reflector that may be used with the flashlight of FIG. 1 in accordance with an embodiment of the invention;

FIG. 5 is a rear perspective view of the flashlight of FIG. 1, with a light beam for the flashlight being shown;

FIG. 6 is a front view comparing the front of the flashlight of FIG. 1 with a human eye;

FIG. 7 is a side view of the flashlight of FIG. 1, showing a light beam emanating from the flashlight in accordance with an embodiment of the invention;

FIG. 8 is front side perspective view of an alternate embodiment of a reflector that may be used with a flashlight in accordance with an embodiment of the present invention;

FIG. 9 is a front view of the reflector of FIG. 8;

FIG. 10 is a section view of the reflector of FIGS. 8 and 9, taken along the section line 10-10 of FIG. 9;

FIG. 11 is a section view of the reflector of FIGS. 8 and 9, taken along the section line 11-11 of FIG. 9; and

FIG. 12 is a section view of the flashlight of FIG. 8, showing an alternate embodiment in which a light bulb is retractable within the reflector.

### DETAILED DESCRIPTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

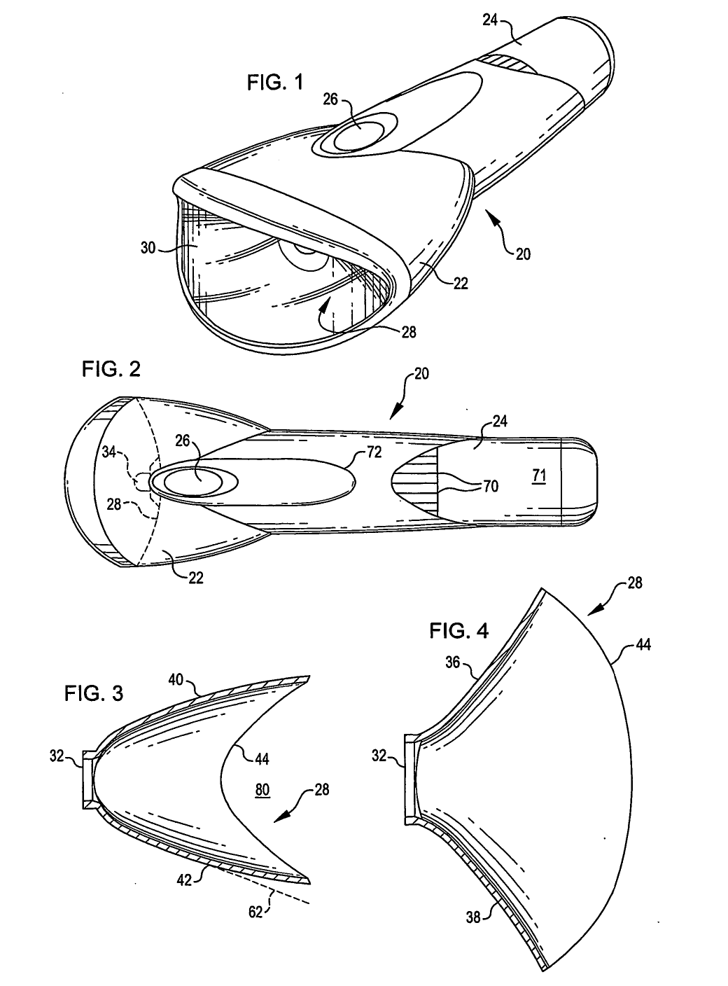

Referring now to the drawings, in which like reference numerals represent like parts throughout the several views, FIG. 1 shows a flashlight 20 incorporating an embodiment of the invention. The flashlight 20 includes a head 22 positioned at the end of a battery retainer 24. A switch 26 is provided for turning on and off the flashlight 20 in a manner known in the art.

Although the flashlight 20 is shown as having the switch 26 adjacent to the head 22, the switch 26 may be positioned at other locations on the battery retainer 24 or the head 22 or may be otherwise provided. In addition, although the head 22 is shown as being aligned in a linear manner with the battery retainer 24, the head 22 may alternatively be at an angle to the battery retainer 24. In addition, the battery retainer 24 and the head 22 may be configured in a different manner than in the embodiment shown in the drawing.

For example, the flashlight 20 may be configured to enable a user to stand the flashlight 20 upright on its end. A configuration wherein the head 22 provides standing of the flashlight 20 may also be provided. To do so, if desired, projections could be provided at the outer edge of the head 22 to permit the flashlight 20 to stand upright for storage.

Briefly described, in accordance with an embodiment of the invention, an elliptical reflector 28 and a curved lens 30 are provided on the head 22. The elliptical reflector 28 and the curved lens 30 permit light to be provided in a wider horizontal plane than a typical round flashlight. Although described with reference to the flashlight 20, the reflector 28 and/or curved lens 30 of the present invention may be used with any light source, including but not limited to bicycle lights, headlamps, automobile lights, and flood lights. The present invention has particular application to portable lights, but not all embodiments are limited to such an application.

The elliptical reflector 28 is a generally cupped shaped body with a circular aperture 32 at its center into which a bulb 34 (FIG. 6) or other source of light (e.g., a light emitting diode (LED)) is inserted. As can be seen in FIGS. 3 and 4, the cupped shaped body includes a right wall 36, a left wall 38, and upper and lower walls 40, 42.

The cross sections of FIGS. 3 and 4 represent cross-sections at approximately a vertical center (horizontal cross section) and horizontal center (vertical cross section) of the elliptical reflector 28, respectively. As further described below, in accordance with an embodiment of the invention, each of the walls 36, 38, 40 and 42 is curved both from the battery retainer 24 to the curved lens 30 and at a direction perpendicular to that direction. Thus, a cross section taken at different locations horizontally or vertically may result in a different view. However, for the purpose of a description of a shape for the elliptical reflector 28, the views shown in FIGS. 3 and 4 will be used.

As can be seen in FIG. 3, the upper wall 40 is shaped as a curve downwardly concave with respect to the cupped shaped body interior that extends between the circular aperture 32 and an outer rim 44 of the elliptical reflector 28. Likewise, the lower wall 42 is shaped as a curve upwardly concave with respect to the cupped shaped body interior that extends between the circular aperture 32 and the outer rim 44.

In accordance with an embodiment of the invention, the left wall 38 is shaped as a curve outwardly convex to the interior of the cupped shaped body between the circular aperture 32 and the outer rim 44, as can be seen in FIG. 4. In this embodiment, the right wall 36 is also shaped as a curve outwardly convex to the interior of the cupped shaped body between the circular aperture 32 and the outer rim 44.

Referring again to FIG. 3, in an embodiment of the invention, the upper wall 40 and the lower wall 42 are symmetrical with respect to a central axis of the cupped shaped body. The interior reflective surfaces of the upper and lower walls 40, 42 form curves concave with respect to the central axis of the cupped shaped body. These interior reflective surfaces are shaped to direct light impinging thereon from a focus point in front of the bulb 34 (FIG. 2) toward the outer rim 44 so that a substantially uniform beam pattern of predetermined vertical extent is formed.

The curve formed by the reflecting surface of the lower wall 42 may be symmetrical to that of the upper wall 40, but is not necessarily so, as is further described below. The precise shape of the curves for the upper wall 40 and the lower wall 42 of the elliptical reflector 28 may be determined by computer modeling techniques well known in the art in accordance with a desired light pattern.

Referring again to FIG. 4, the left wall 38 and the right wall 36 are symmetrical with respect to a central axis of the cupped shaped body. The interior reflective surfaces of the right and left walls 36, 38 form outwardly convex curves arranged to direct light impinging thereon toward the outer rim 44 so that a beam pattern of predetermined horizontal extent is formed. The reflecting surfaces of right and left walls 36, 38 are curved to direct light rays impinging thereon from the light source so that the light rays emerging from the rectangular opening form a uniform beam over a predetermined horizontal range.

The focus points of this curve are exterior to the cupped shaped body and behind the cupped shaped body. In the embodiment shown in the drawings, the curve formed by the reflecting surface of the right wall 36 is symmetrical to that of the left wall 38, but this arrangement is not required. The precise shape of the curve for the right and left walls 36, 38 of the reflector may be determined by computer modeling in accordance with a desired light pattern.

The combination of the concave curved upper and lower walls 40 and 42 and the outwardly convex right and left walls 36, 38 limit the extent of the beam in both the vertical and horizontal directions to provide a uniform flood beam. This arrangement is further described in the Sedovic et al. patent, set forth in the background section of this disclosure.

For the embodiment shown in FIG. 4, the convex surfaces of the right and left walls 36, 38 are preferably provided at the outer extents of the right and left walls 36, 38. Because the elliptical reflector 28 is rounded, the junctures between the right and left walls 36, 38 and the upper and lower walls 40, 42 are not well defined. Preferably, however, in accordance with an embodiment, at a central portion of the elliptical reflector 28, the right and left walls 36, 38 have a cross section in which the walls are convex in shape, as is shown in the example in FIG. 4. In addition, in accordance with an embodiment, the upper and lower walls 40, 42 have a cross section taken vertically at the center of the elliptical reflector 28 in which the two walls are concave relative to a center of the elliptical reflector 28, such as in the example shown in FIG. 3.

In accordance with an embodiment of the invention, the transition between the convex right and left walls 36, 38 and the concave upper and lower walls 40, 42 is gradual. Thus, the sides of the elliptical reflector 28 are constantly curved so that they transition from the convex shape of the right and left walls 36, 38 shown in FIG. 4 to the concave shape of the upper and lower walls 40, 42 shown in FIG. 3. As such, the elliptical reflector 28 may be configured so that the gradually-transitioning surfaces reflect outward, so there are few or no dark spots in a light pattern provided by the elliptical reflector 28. The proper surface curvature of the gradually-transitioning surfaces may be determined by computer modeling for a desired light pattern.

In an alternative embodiment of the present invention, the right and left walls 36, 38 have a concave shape similar to the upper and lower walls 40, 42 shown in FIG. 3. As such, the transition between the right and left walls 36, 38 and the upper and lower walls 40, 42 remains concave. Again, the curve of such walls can be determined by computer modeling and can be matched to generate a desired light pattern.

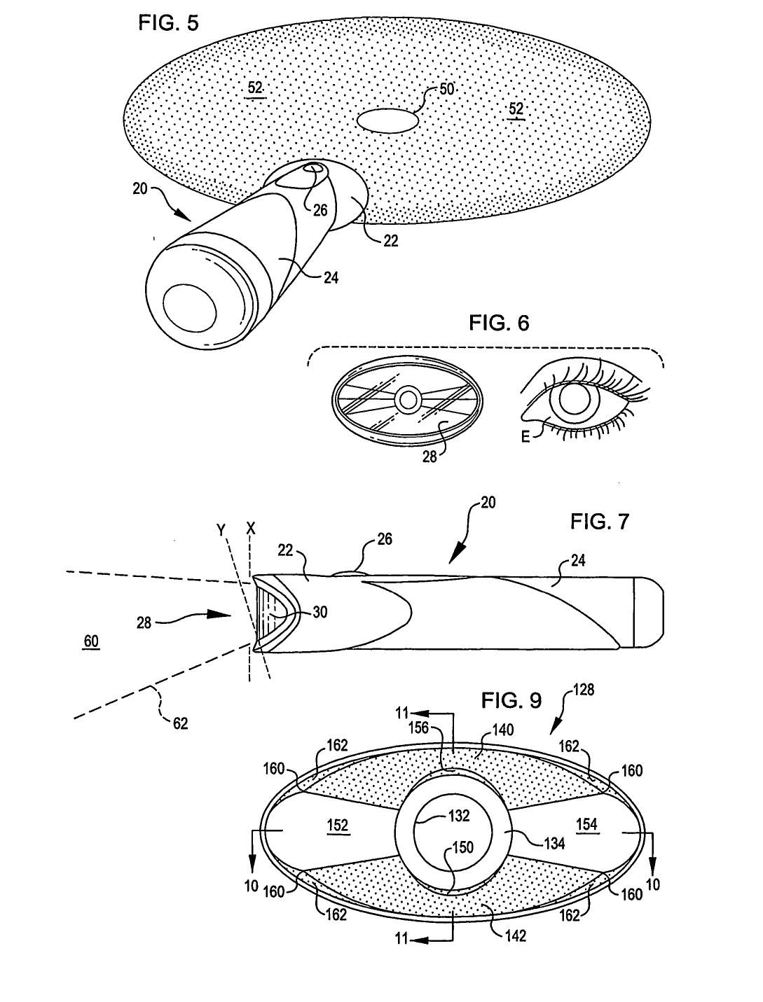

In accordance with an embodiment of the invention, as can be seen in FIGS. 5 and 6, the elliptical reflector 28 provides a concentrated, small light beam 50 and a wider outer light beam 52, such as a flood beam. The small, central light beam 50 may be any desired shape, such as circular or elliptical. Similarly, the outer light beam 52 may be any desired shape but, in accordance with an embodiment of the present invention, is elliptical to match the peripheral vision of a human. In this manner, the light pattern provided by the elliptical reflector 28 closely matches the vision of a human. That is, the small concentrated light beam 50 matches the direct viewing area of the eyes, and the less bright, larger elliptical light beam 52 more closely matches the peripheral vision of a user. To this end, as can be seen in FIG. 6, the shape of the elliptical reflector 28 closely resembles that of a human eye E.

The walls 36-42 of the elliptical reflector 28 may be configured as desired so as to collimate light toward the bright center beam 50. The remaining interior surface of the elliptical reflector 28 is used to spread the light outward and to provide the larger elliptical light beam 52. For example, the convex right and left walls 36, 38 shown in FIG. 4 may be used to allow more of the light to project directly outward from the bulb 34 to illuminate the far outer edges of the larger elliptical light beam 52.

In accordance with an embodiment of the invention, the flashlight 20 is designed so that it directs most light for the outer light beam 52 outward (i.e., straight out of the reflector and along an axis that extends through the flashlight 20), but also directs some of the light downward so that the light is available for illuminating a path, such as on a trail. For example, the light beam 60 shown in FIG. 7 extends primarily outward from the flashlight 20 and also downward.

To provide this function, the elliptical reflector 28 may not be symmetrical about the upper and lower walls 40, 42. Therefore, the light from the bulb 34 (FIG. 2) incident to the upper and lower walls 40, 42 causes the light pattern 60 to be generated in the manner shown in FIG. 7, or to otherwise be generated so that the light pattern is directed primarily outward and at least partly downward. In an alternative way of providing this function, the bulb 34 may not be centered within the elliptical reflector 28.

As another alternative, the outer rim 44 of the elliptical reflector 28 may not be symmetrical. For example, as shown by the dotted line 62 in FIG. 3, the lower wall 42 may extend downward so as to allow the light to be directed downward. Thus, in accordance with this embodiment, the upper wall 40 and the lower wall 42 are not symmetrical. Instead, the lower wall includes an oblong portion that permits some of the light pattern to be directed downwardly.

In such an embodiment, the light pattern emanating from the elliptical reflector may be similar to that shown in FIG. 5, with the difference being that the outer light beam 52 will extend down further. As such, the more concentrated inner light beam 50 is not centered in the outer light beam 52.

Thus, from the foregoing, it is apparent that the elliptical reflector 28 is not necessarily elliptical in the strict sense of the definition of “elliptical.” Instead, the elliptical reflector 28 is cupped shaped and configured to produce light more in a horizontal dimension than in a vertical dimension, preferably having rounded edges, and being at least somewhat elliptical in nature. Thus, as used herein, “elliptical” is meant to cover such shapes, even if not symmetrical, and may be a variety of shapes in accordance with a desire of a designer, including oblong in one dimension or more, or otherwise not symmetrical in one or more planes. However, in general, the light pattern produced by the elliptical reflector 28 is longer in the horizontal dimension than in the vertical. This feature will likely result in the elliptical reflector 28 itself being longer in the horizontal dimension, although not necessarily so. Also, in accordance with an embodiment, the elliptical reflector 28 includes rounded inner surfaces so that few or no dark spots are provided in a light pattern emanating from the elliptical reflector 28.

In accordance with an embodiment of the invention, the flashlight 20 may be configured so as to vary the relative positions of the bulb 34 (FIG. 2) relative to the elliptical reflector 28. Such a feature is known in the art, and generally results in adjustment of the light emanating from the flashlight 20 from broad and diffuse to narrow and concentrated. By moving the bulb 34 relative to the elliptical reflector 28, a desired beam size may be provided.

FIG. 2 shows markings 70 on a portion 71 of the battery retainer 24. In an embodiment of the invention, the portion 71 of the battery retainer 24 rotates relative to a sleeve 72 to provide the inward and outward movement of the bulb 34 relative to the elliptical reflector 28.

In accordance with an embodiment of the invention, the outer rim 44 of the elliptical reflector 28 is curved. As can be seen in FIG. 2, from a top view, the outer rim 44 forms an arc having a center axis that extends vertically through the flashlight 20. The curved lens 30 fits on the outer rim 44.

The outer rim 44 and corresponding curved lens 30 provide additional structure for creating a light pattern that is wide in a horizontal dimension. The curved structure of the outer rim 44 provides set back portions, or openings 80 (FIG. 3) on opposite sides of the elliptical reflector 28, specifically at the outer left and right edges of the outer rim 44. Thus, the rounded outer rim 44 causes the outer extremities of the right and left walls 36, 38 of the outer rim 44 to be set back from the outer edges of the upper and lower walls 40, 42, as can be seen in FIG. 3, 4, and 7. This feature allows a designer to constrain the light beam in the vertical dimension and broaden the light in the horizontal, consistent with the presentation of a light pattern that is more horizontal than vertical. If desired, the outer rim 44 and the curved lens 30 may cut back at the outer right and left walls an amount that is sufficient to provide up to approximately 140 degrees of illumination in the horizontal, or even greater for some applications. For example greater illumination may be provide such as 160 degrees of horizontal illumination, or even as much as 180 degrees.

In an embodiment, the elliptical reflector 28 is shaped so that an aspect ratio for the less bright, larger elliptical light beam 52 is approximately 5:1, width to height. As described above, the inside profile and shape of the walls of the elliptical reflector 28 may be configured to provide this function. In the embodiment shown, the openings 80 also aid in providing this function, although the openings are not required for providing such a function.

As can be seen in FIG. 7, in accordance with an embodiment of the invention, the outer edges of the upper and lower walls 40, 42 may extend an equal amount out of the front of the flashlight 20, as indicated by the line X drawn across the front edges of these two walls 40, 42. In accordance with an alternate embodiment of the invention, to provide additional downward illumination, the outer edge of the lower wall 42 may not extend out as far as the outer edge of the upper wall 40, causing the outer edge of the lower wall 42 to be recessed relative to the outer edge of the upper wall 40. Although such an embodiment is not shown, the line Y in FIG. 7 is an example of a line that may intersect the outer edge of the upper and lower walls 40, 42 in such an embodiment. Such an embodiment would further enhance the ability of the elliptical reflector 28 to direct light at least partly downward in addition to a primary outward beam.

In summary, the elliptical reflector 28 and the curved lens 30 provide a benefit beyond standard round reflector and lens patterns. Specifically, the elliptical reflector 28 and the curved lens 30 provide light in locations where it is needed most (i.e., outward and perhaps also downward) and in a elliptical, primarily horizontal pattern that more closely matches the viewing window of a human.

The elliptical reflector 28 may provide both a concentrated small light beam (e.g., the light beam 50) and a wider outer light beam (e.g., the light beam 52) to more closely match the concentrated central viewing of a user and the associated peripheral vision of a user. In addition, instead of light being directed in an upward direction, such as with typical round lenses, light is provided on a wider horizontal plane. In addition, if desired, additional light may be directed downward to light a dark path, for example.

In one example, the front edge of the reflector, from a top view, is shaped as a parabola with a curvature defined by X=78* Y². The back edge of the reflector taken along the same cross-section is defined by X=115.56*Y². A cross section taken vertically has a back edge defined by the parabola X=13*Y². This is one embodiment of a reflector that provides an elliptical pattern of light.

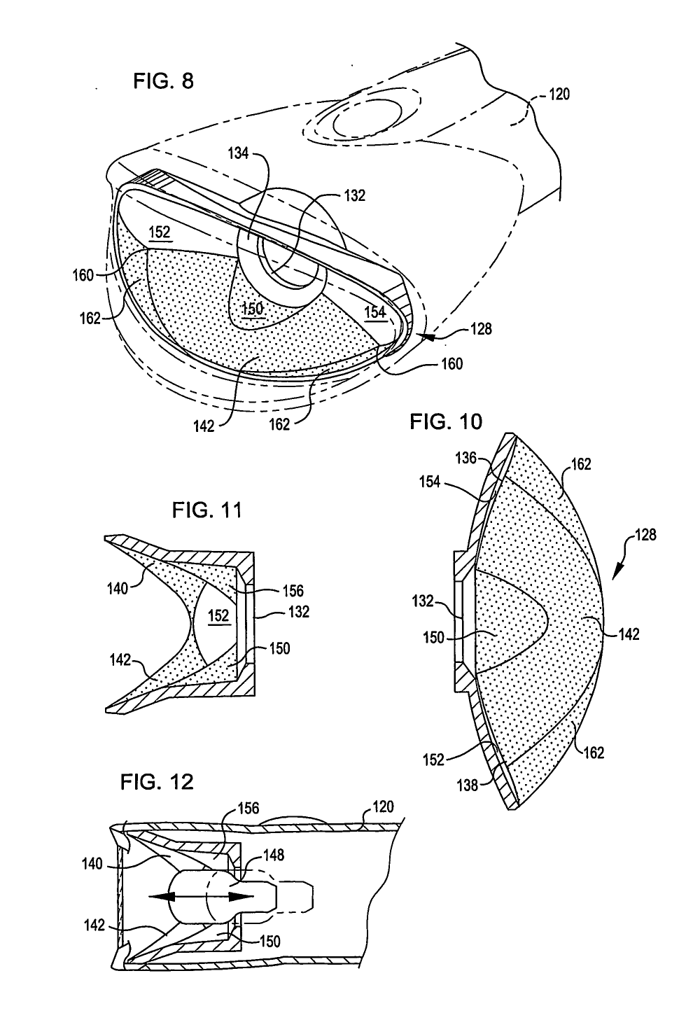

An alternate embodiment of a reflector 128 in accordance with the present invention is shown in FIG. 8. Reflector 128 is shown attached to a flashlight 120, but may be used for other portable or non-portable lighting devices.

The reflector 128, like the reflector 28, includes an opening 132 for receiving a light bulb, lens, or other lighting mechanism. The opening 132 is surrounded by a base 134. The reflector 128 also includes a left wall 138, a right wall 136 (both shown in FIG. 10), a top wall 140, and a lower wall 142 (both best shown in FIG. 11).

In the embodiment shown in the drawings, the reflector 128 includes a lower cupped portion 150 and an upper cupped portion 156. The lower and upper cupped portions 150, 156 are located above and below the bulb, such as the bulb 148 shown in FIG. 12. The upper and lower cupped portions 150, 156 are arcuately shaped, with the arcs formed by the portions being shaped so that they are spaced somewhat evenly from the sides of the bulb 148. The upper and lower cupped portions 150, 156 aid in refracting and reflecting light from the bulb 148 and direct that light to a concentrated location, such as the small light beam 50 described with reference to FIG. 5.

The reflector 128 also includes left and right cupped portions 152, 154. These cupped portions extend from the base 134 outward to the outer left and rightmost portions of the reflector 128. The cupped portions 152, 154 are concave in configuration. The cupped portions 152, 154 are preferably arranged so that they align with the bulb 148, and are generally arranged so that light from the bulb that is incident with one of the cupped portions 152, 154 is directed to a concentrated location, such as the small light beam 50 described with reference to FIG. 5.

The left and right cupped portions 152, 154 extend adjacent to and underneath and over the top wall 140 and lower wall 142. The outer extents of these surfaces culminate in points 160. The fact that the top and lower walls 140, 142 are cupped, and the left and right cupped portions 152, 154 are also cupped causes the outer extents, or outer portions 162 of the reflector 128 to be sloped so that, for the most part, light emanating from the bulb 148 is not incident to these surfaces.

In an embodiment, selective surfaces of the reflector 128 may be highly reflective, or polished, with other surfaces being dull, unpolished, or rough to provide a desired effect. As an example, in the embodiment shown, the upper and lower cupped portions 150, 156, the top wall 140, the lower wall 142, and the outer portions 162 all include dulled surfaces (indicated by the dotted surfaces), whereas the left and right cupped portions 152, 154 and the base 134 include highly reflective surfaces (not dotted). In this manner, light may be more appropriately focused, for example to form the bright concentrated center spot 50 shown in FIG. 5 (via the base 134), and a less bright outer light beam 52 (via the reflection from the left and right cupped portions 152, 154).

If desired, as shown in FIG. 12, the bulb 148 may be retractable within the reflector 128 so as to adjust the light emanating from the reflector 128 from broad and diffuse to narrow and concentrated. By moving the bulb 148 relative to the reflector 128, a desired beam size may be provided.

The embodiment shown in FIG. 8 also provides a wide pattern of light that is constrained vertically. In an embodiment, light emanating from the bulb 148 is constrained by the upper and lower walls 140, 142 to an angle of 71.91 degrees, and is broadcast 148.68 degrees by the left and right walls 138, 136. Other angles may be provided.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A portable light, comprising:
a light source;
a power source for powering the light source;
an elliptical reflector for broadcasting a beam from the light source and having an outer rim, the outer rim of the elliptical reflector being curved; and
a curved lens mounted along the outer rim of the reflector.

2. The portable light of claim 1, wherein the reflector is configured and arranged to provide a small, concentrated beam of light and an outer, elliptical flood beam.

3. The portable light of claim 1, wherein the reflector comprises a leading edge having a central portion that extends out further than side portions.

4. The portable light of claim 1, wherein the reflector is configured and arranged to provide a light pattern in which a primary beam of light is directed straight out from the reflector, and additional light is directed more downward from the reflector than upward.

5. The portable light of claim 4, wherein a lower wall of the reflector extends downward more than a top wall so as to allow a portion of the light to be directed downward.

6. The portable light of claim 1, wherein the portable light is a flashlight.

7. The portable light of claim 6, wherein the flashlight is configured to be supported upright on a surface with an outer portion of flashlight adjacent the reflector engaging the surface.

8. The portable light of claim 7, wherein the the outer portion of the flashlight comprises protrusions for engaging the surface.

9. The portable light of claim 1, wherein a top wall of the reflector is downwardly concave relative to an interior of the reflector, and a lower wall is upwardly concave relative to the interior.

10. A portable light comprising:
a light source;
a power source for powering the light source;
an elliptical reflector for broadcasting a beam from the light source and having an outer rim, a top wall a bottom wall, a left wall, and a right wall, the outer rim of the elliptical reflector being curved the top wall of the reflector being downwardly concave relative to an interior of the reflector, and the lower wall is upwardly concave relative to the interior and the left wall and a right wall being shaped as a curve outwardly convex to the interior; and
a curved lens mounted on the reflector

11. The portable light of claim 1, wherein the reflector comprises an upper wall, a lower wall, a right wall and a left wall, and wherein the upper wall and lower wall are spaced so as to constrain light emanating from the reflector in a first dimension and the left wall and right wall are spaced and arranged so as to broadcast light emanating from the reflector in a second dimension.

12. The portable light of claim 11, wherein the portable light is arrangeable so the first dimension is vertical, and the second dimension is horizontal.

13. A portable light, comprising:
a light source;
a power source for powering the light source;
an elliptical reflector for broadcasting a beam from the light source and having an outer rim, the outer rim of the elliptical reflector being curved, the elliptical reflector having an upper wall, a lower wall, a right wall, and a left wall, and wherein the upper wall and lower wall are spaced so as to constrain light emanating from the reflector in a first dimension and the left wall and right wall are spaced and arranged so as to broadcast light emanating from the reflector in a second dimension and at least 140 degrees; and
a curved lens mounted on the reflector.

14. The portable light of claim 13, wherein the left wall and right wall are spaced and arranged so as to broadcast light at least 160 degrees.

15. The portable light of claim 14, wherein the left wall and right wall are spaced and arranged so as to broadcast light at least 180 degrees.

16. The portable light of claim 11, further comprising:
a light source in the elliptical reflector; and
an axis extending through the elliptical reflector and aligned along a direction of light emanating from the light source out of the elliptical reflector;
wherein outer leading edges of the left and right walls are set back in a direction parallel with the axis and toward the light source more than outer leading edges of the upper and lower walls.

17. The portable light of claim 16, wherein the right and left walls each comprise a concave cupped inner surface extending from the light source outward and at least a portion of which does not extend to the outer edges of the upper and lower walls.

18. The portable light of claim 17, wherein the concave cupped inner surface extends outward to an outer portion of the right and left walls.

19. The portable light of claim 17, wherein the concave cupped inner surface is arranged and configured to provide a small, concentrated beam of light, and other portions of the elliptical reflector provide an outer, elliptical flood beam.

20. The portable light of claim 19, wherein the cupped inner surface is more reflective than the other portions.

21. The portable light of claim 20, wherein the cupped inner surface is polished.

22. A portable light, comprising:
a light source;
a power source for powering the light source;
an elliptical reflector for broadcasting a beam from the light source and having an outer rim, the outer rim of the elliptical reflector being curved, the elliptical reflector having an upper wall, a lower wall, a right wall, and a left wall, and wherein the upper wall and lower wall are spaced so as to constrain light emanating from the reflector in a first dimension and the left wall and right wall are spaced and arranged so as to broadcast light emanating from the reflector in a second dimension, and wherein the right and left walls each comprise a concave cupped inner surface extending from the light source outward and at least a portion of which does not extend to the outer edges of the upper and lower walls; and
a curved lens mounted on the reflector.

23. The portable light of claim 22, wherein the concave cupped inner surface extends outward to an outer portion of the right and left walls.

24. The portable light of claim 22, wherein the concave cupped inner surface is arranged and configured to provide a small, concentrated beam of light, and other portions of the elliptical reflector provide an outer, elliptical flood beam.

25. The portable light of claim 24, wherein the cupped inner surface is more reflective than the other portions.

26. The portable light of claim 25, wherein the cupped inner surface is polished.
